(19) United States
(12) Patent Application Publication
(10) Pub. No.: US 2010/0058923 A1
(43) Pub. Date: Mar. 11, 2010

(54) Straight-line piston fluid engine with wobble drive valve actuation

(76) Inventor: Robert R. Green, Laguna Woods, CA (US)

Correspondence Address: ROBERT R. GREEN, 2337 B AVENIDA SEVILLA, LAGUNA WOODS, CA, 92637, US

(21) Appl. No.: 12/231,907

(22) Filed: Sep. 8, 2008

(51) Int. Cl. F01B 3/10; F01B 3/02; F16H 23/08

(52) U.S. Cl. 91/480; 91/499; 74/60

(57) ABSTRACT

An axial piston fluid engine having single-acting cylinders incorporating swivel-joint attachment of the cylinders to rotary control valves wherein straight-line piston movement is established for the elimination of side forces on the pistons. The pistons and the control valves are operatively connected to a common wobble drive member and arranged in geometry of lever positions to coactively time the drive fluid into and out of the cylinders intermittently.

### BACKGROUND OF THE INVENTION

This invention relates to an axial piston fluid engine with single-acting cylinders pivotally attached to rotary valves that are actuated by a wobble drive member.

Axial piston steam engines of the type having a plurality of pistons along parallel axes pivotally operated by a wobble plate mechanism are known in the art. An example may be seen in U.S. Pat. No. 4,491,057 (Ziegler, 1985). As in other examples such as U.S. Pat. No. 4,106,354 (Girodin, 1978), the engines are encased in a rigid block and have fixed, stationary cylinders. The pistons have ball-jointed piston rods that push and pull a wobble plate mechanism to convert the piston motion into rotary movement.

The engines in these examples have many precisely machined parts and castings as well as an engine block for encasement. The engines are relatively heavy for the power they can produce. The pistons are subject to side pressures from the angular piston rod alignment. Additional piston extensions and seals are needed to accommodate the ball-jointed rods attached to the pistons. Side forces associated with angular piston rod alignment cause pressure against the sides of the pistons and the connecting rods to the wobble plate. The pressure on the pistons, joints and seals require frequent lubrication in places that are not easily accessible. Worn seals and joints are not easily replaced.

No such engine has been adopted for use on a wide scale. The lack of commercial exploitation of this type of engine is probably due to the relative high cost of manufacture as well as maintenance and lubrication issues. Scaling for large and small engines may also be problematic due to the confined space for valve plumbing and actuation. The space restraints between the cylinders prescribe small port openings with restricted gas flow.

### SUMMARY OF THE INVENTION

The object of the present invention is to provide improvements to axial piston engines by providing a modular engine with variable number of cylinders that is easily scalable for large and small applications. It is further object to reduce friction by eliminating side forces to the piston. This is accomplished by providing straight-line movement with fewer parts. Reduced weight of reciprocating mass and minimal lubrication requirements are the results of this new arrangement. The valve arrangement allows room for large port sizes for the free flow of fluids. The economy of structure facilitates uncomplicated and economical manufacturing.

In accordance with the present invention, one to eight axial piston cylinders rotate and swivel freely on hollow ball-swivel joints at the base of each cylinder to allow the cylinder to adjust, swivel and pivot with the movement of piston disks attached to piston rods. The piston rods are attached to pivoting drive points around a central wobble drive member. Intermediate the piston disks and the pivoting drive points, a tubular piston rod-guide is centered in a bracket attached to the cylinders to procure alignment of the piston disks within cylinders. The wobble drive member has a central pivot point established by a flexible rod or a universal joint on the crankshaft axis. The wobble drive member conveys the reciprocated movement of the piston disks to a single crank-pin pivotally connected at an angle to the axis of the crankshaft. The aforementioned ball-swivel joints pivotally connect the base of the cylinders to rotary valves that are provided to port fluid to and from the cylinders. The advantageous position of the valves at the base of the cylinders provides ample room for large valve ports to facilitate fluid exchange. Levers controlled by linkage rods operate the valves. The linkage rods are actuated from a connection point on the wobble drive member at substantially 90 degrees from the piston rod drive points of its associated cylinder. The arrangement of the valve linkage connection points on the wobble drive member, provides precise intermittent timing of the intake and exhaust phase of the valves to hold full intake and exhaust positions for the substantial length of the piston strokes.

The axial reciprocating movements of the piston disks are converted into uniform rotation of the crankshaft with greater economy of parts and less reciprocated mass. By means of the forgoing arrangement, the piston drive point displacement along the arcuate path of the wobble drive member is transformed into a straight-line movement of the piston disks within the cylinders. A single “O” ring seal can thus be employed to seal the piston disk within the cylinder wall. Reduced contact between the piston disks and the cylinder walls result in less friction and minimal lubrication requirements. Advantageously, saturated steam can provide adequate lubrication under normal operation.

Other objects and advantages of this invention will become apparent in the detailed description of the straight-line fluid engine as follows.

### BRIEF DESCRIPTION OF DRAWING FIGURES

FIG. 1 is a perspective view of a four-cylinder axial piston engine in accordance with one embodiment of the present invention;

FIG. 2 is a perspective view of a partially exploded single module of an axial piston engine incorporating the essential elements of the embodiment of the present invention;

FIG. 3 is a traverse section view of the preferred embodiment of the rotary valve and ball swivel joint of the machine as taken through a plane indicated by section line III-III in FIG. 4. Three positions of the valve stem are illustrated;

FIG. 4 is a side elevation view taken substantially through a plane indicated by section line IV-IV in FIG. 3. Partial cutaway of the valve bushing and valve body is shown;

FIG. 5 is a perspective view of a valve arrangement of a four cylinder engine in accordance with one embodiment of the present invention;

FIG. 6 shows a partial view of a six-cylinder engine of the present invention showing the relative position on the wobble drive member of the piston and the valve drive points.

### DETAILED DESCRIPTION OF THE PREFERRED EMBODIMENT

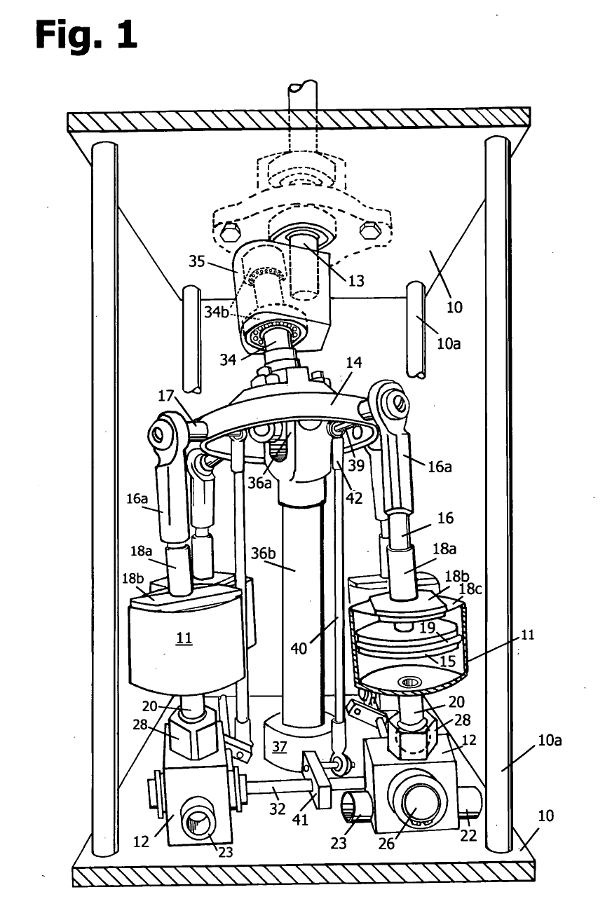

Referring to the drawings in detail, FIG. 1 illustrated as the preferred embodiment an axial-piston engine having a frame assembly with four legs 10a connecting two end walls generally referred to by numeral 10 supporting in proper operational relationship four basic components consisting of four identical, articulating cylinder assemblies 11, pivotally attached to fixed steam induction valve assemblies 12, an output crankshaft 13, a wobble drive member 14 operatively interconnecting the cylinder assemblies with the crankshaft.

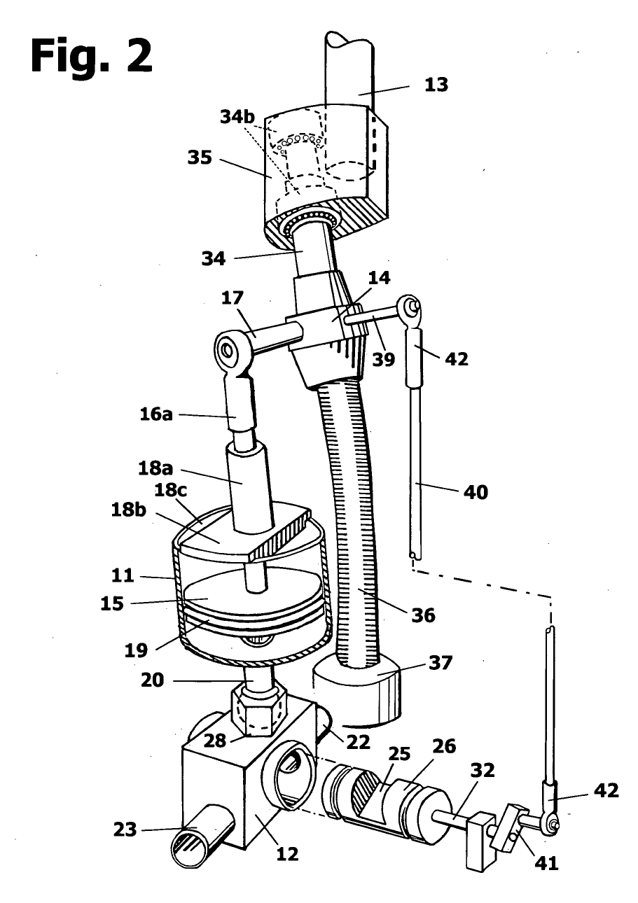

Cylinder assemblies 11 as shown in FIG. 1 and FIG. 2 consisting of a cylinder pivotally connected to valve assembly 12 by a ball swivel-socket joint 20. Tube 20 is fastened to the bottom of the cylinder and contains a hollow ball made of a durable metal or ceramic material and fits pivotally into an equally durable swivel-socket joint 28 that is replaceably joined to valve 12. A piston-disk 15 within the cylinder is displaceably connected by a connecting rod 16, and aligned to the cylinder by a piston rod guide assembly 18 having a guide tube 18a and a tube bracket 18b having square sides functioning as cylinder air vents 18c. Piston-disk 15 is provided with a piston ring seal 19 preferable consisting of a well-known “O” ring seal. The opposite end of connecting rod 16 is adjustably secured by a threaded connection to a rod-end 16a thus completing the cylinder assembly.

FIG. 2 shows a partially exploded view of a single module of the preferred embodiment of the present invention. The single axial cylinder assembly 11 operationally connected to a piston arm 17 on wobble drive member 14 rotates an axial crank pin 34 with fixed, single axis journals 34b about the axis of a single throw crank 35. The journals 34b are disposed from each other at a distance to provide stable support of the crank-pin. Wobble drive member 14 is centrally pivoted on a flexible rod 36 that is anchored and rigidly fixed to the wobble pivot member 14 and supported by a frame anchor 37 so that the pivot point lies on the main crankshaft axis. Another embodiment of the central pivot device is described in FIG. 1 wherein a well-known universal joint 36a is employed and can be seen anchored to frame wall 10 by a support column 36b and to wobble drive member 14. Wobble drive member 14 additionally provides an elongate valve lever 39 substantially disposed at right angle on the radius of the circular plane on wobble drive member 14 relative to the elongate piston arm 17 for actuation of a valve push-rod 40. The geometry involved in such a linkage drive connection between piston lever 17 and valve lever 39 establishes intermittent valve timing wherein fluid is communicated to and from the cylinder for substantially the full intake stroke and the full exhaust stroke of the piston. Piston movement is temporarily suspended during the opening and closing phase of the valve in accordance with the geometry of the present embodiment. Valve push-rod ends 42 pivotally align push rods with valve shaft lever 41. A valve shaft 32 conveys rotation of lever 41 to valve stem 26.

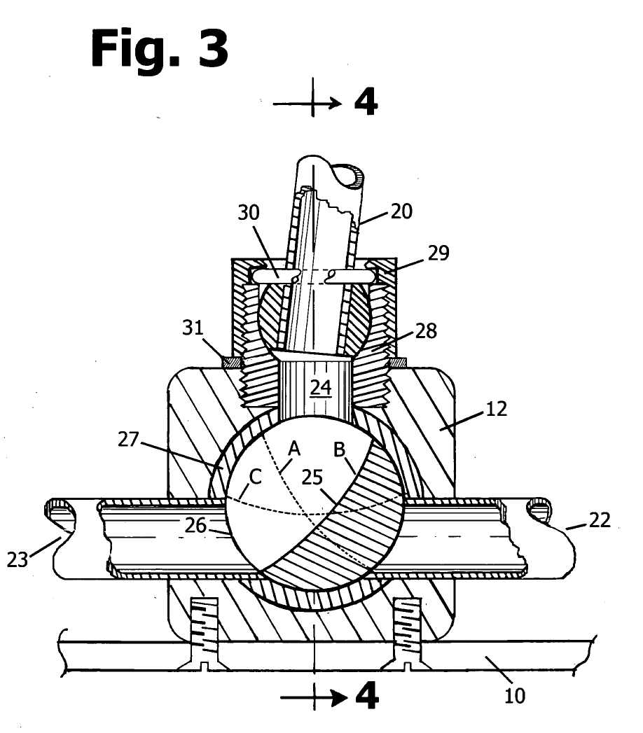

Steam induction valve assembly 12 is detailed in FIG. 3 of the preferred embodiment and consists of valve body 12, providing three ports for the communication of fluid to and from cylinder assemblies 11. Interchangeable, intake port 22 and exhaust port 23 direct fluids into and out of a cylinder port 24 through swivel tube 20. Fluid is selectively directed in and out of the cylinders by stem cutout 25 in valve stem 26. Rotational direction of the engine may be determined by the inversion of the intake and exhaust ports. Three positions of the partially rotated cutout 25 are shown in FIG. 3 as intake A, exhaust B, and closed C. A valve bushing 27 is provided to journal valve stem 26. A swivel-socket joint 28 is adjustably threaded into valve body 12 providing a replaceable socket for swivel tube 20. A cap-nut 29 serves as a retainer for swivel tube 20. An “O” ring 30 further seals against leaks. A shim washer 31 adjustably limits “O”ring 30 compression. Valve shaft 32 rotates valve stem during engine operation.

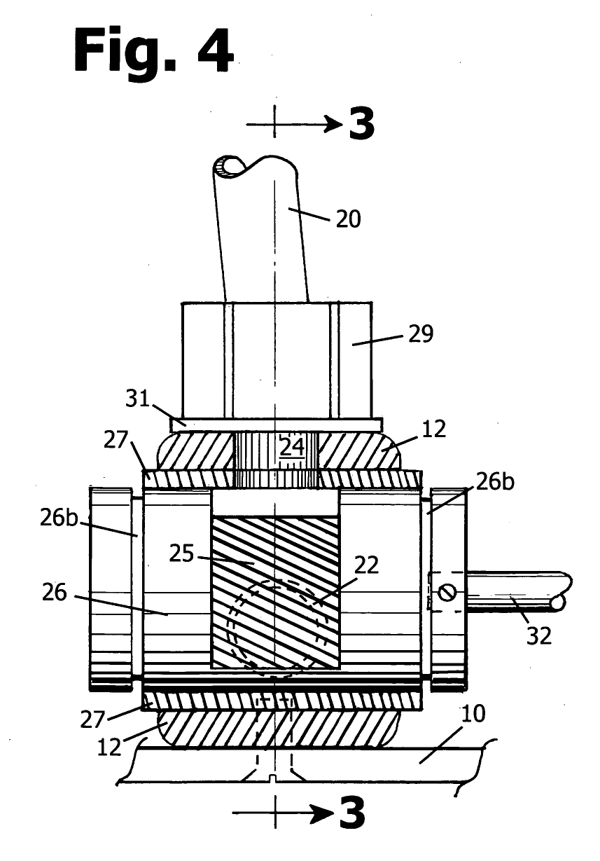

Valve body 12 in FIG. 4 shows the side view of valve cutout 26 as in Fig.3 wherein the angular disposed position of the cutout directs fluid into or out of one port while shutting fluid flow to and from the second port. Valve shaft 32 rotates the valve stem. Retainer grooves 26b are provided for retainer rings (not shown).

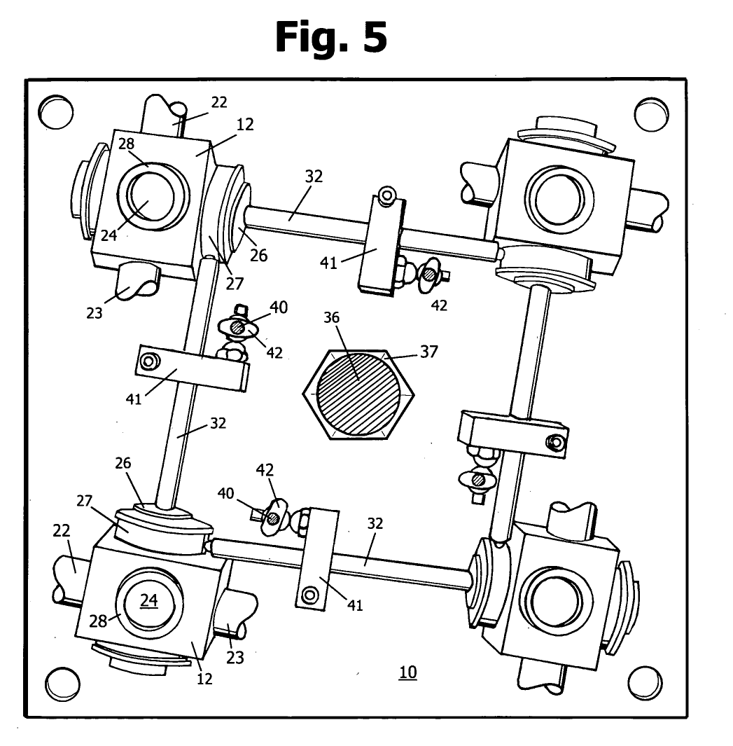

FIG. 5 illustrates an embodiment wherein the valve arrangement of a four-cylinder machine is shown as one configuration of a modular machine that can have a selective plurality of cylinders. The configuration of the valve arrangement is variable and is expandable or contractible to accommodate a wide selection of cylinder sizes and length of the piston stroke. Valve-shaft levers 41 are positioned radially in general alignment with push rods 40 to perform an appropriate link with valve shaft levers 39 (FIG. 1, 2, 6). Valves 12 are arranged in operational relation for sequential timing for each cylinder. Levers 41 are reciprocally rotated by push rods 40. Shafts 32 fixed to lever 41 impart partial rotation of the valve stem 26. Bushing 27 serves as a traverse support bearing 21 for shaft 32.

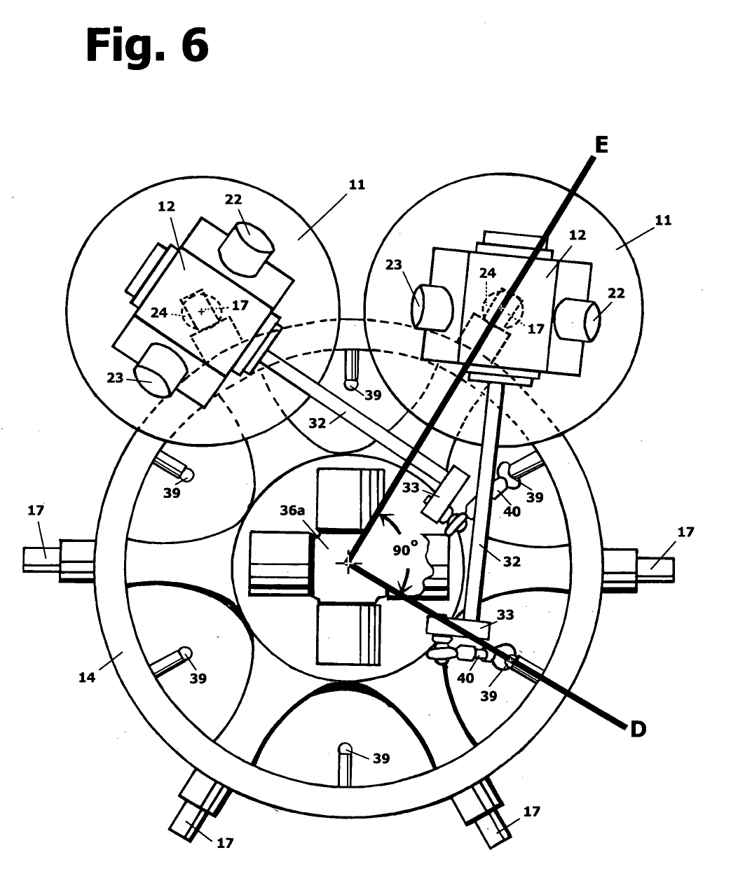

FIG. 6 shows a partial view of a six-cylinder machine viewed from below. Six piston arms 17 are shown in relation to six valve levers 39. Two cylinder assemblies 11 with their respective attached valves 12 further describing operational arrangement of the present invention provide valve and piston timing in sequential phases. Each valve lever 39 attachment position of the preferred embodiment is placed along one leg of a right angle D. Each cylinder port 24 is established along a second leg of right angle E. The position of the cylinder port 24 and piston arm 17 along leg E determines the length of the piston stroke. Changing the length of the piston stroke has no effect on the valve operation wherein the valve will continue to open coactively for the full length of the stroke for any selected position along leg E. The relative right-angle operational position of the piston arms and valve levers on the wobble drive member 14 as illustrated in FIGS. 1,2,5, and 6 are consistent for any number of cylinders but not limited to actuation of mechanical valves. Actuation of electronic valve-switches is an example of another arrangement of the preferred embodiment.

It should be appreciated that in accordance with the present invention at least one to eight cylinder assemblies are associated with the present invention, one, four and six cylinder examples being described in connection with the illustrated embodiment. While the above description contains many specificities, these should not be construed as limitations of the scope, but rather as an exemplification of one embodiment thereof. Many variations are possible. For example, cylinders may be made of glass, stainless steel, copper, ceramic, carbon fiber, aluminum or any substance suitable to the pressure, temperature and corrosion resistance required for specific operations. Cylinder sizes may be selectively determined and may have different functions. All or a selected number of the cylinders may function as pumps providing a combination of pump and engine. Compressed air, refrigerant or other phase change fluids may be used as a drive fluid. Piston seals may be made of a variety of materials such as rubber, carbon fiber, PTFE or metal depending on the drive fluid and temperature of operation. Crankshaft 13 may be a member of the engine or it may be a member of a separate device such as a generator, refrigerant pump, or water-pump for example. Cylinder assemblies may be quickly exchanged for different power requirements. The wobble drive may incorporate different pivotal devices such as a flexible rod or a common universal joint.

### CONCLUSIONS AND RAMIFICATIONS

The combination of components of the fore-described machine of the present invention has produced a modular machine with reduced friction between the cylinders and the pistons due to the straight-line, reciprocal movement of the pistons. The resulting elimination of side forces on the piston preclude heavy piston rods and pistons, and allows the use of “O” ring seals to replace metal rings and tight tolerances. Lubrication requirements are also greatly reduced. In most cases, steam is sufficient lubrication when applied as a steam engine.

Because of low structural complexity, the engine of the present invention may be scaled easily to large or small sizes. The power to weight ratio becomes smaller as the size and number of cylinders increase. The typical engine block has been entirely eliminated in the present embodiment. Heat loss from the cylinders is easily prevented because individual cylinders are isolated from the mass of the engine structure and are easily insulated. Low reciprocal mass associated with the machine further increases efficiency. The improved machine provides lightweight construction, simplicity and versatility resulting in economical production cost compared with other fluid machines.

I claim:

1. An axial piston machine comprising at least one single-acting cylinder assembly in swiveled connection to a control valve assembly; the cylinder and the valve connected in pivotal operative relation to a wobble drive means including a crank-pin, an elongate piston arm and an elongate valve lever; the arm and lever operating as a unit and disposed relatively on the drive means at substantially right angle to central axis of said wobble drive means whereby, the arranged improvement establishes straight-line motion in a piston reciprocally operated within the cylinder by intermittent, timed porting of fluid into and out of the cylinder for providing rotary energy in a main-shaft.

2. The machine as defined in claim 1 further including,
a) a swivel-socket joint pivotally connecting said cylinder assembly to said control valve assembly,
b) a piston within the cylinder rigidly secured to a connecting rod,
c) a connecting rod guide means vertically fixed in center of the cylinder for alignment of said piston to the cylinder establishing straight-line movement of said piston in the cylinder and,
d) a connecting rod-end attached to said connecting rod and pivotally attached to said piston arm for causing rotation in said wobble drive means.

3. The machine in claim 1 further including,
a) a means adjusting said swivel-socket joint for swivel attachment of said cylinder assembly to said valve assembly,
b) a valve body having three ports;
c) a valve-stem traversing through said valve body providing selecting control means for directing fluid through said three ports; said control means including a valve stem cutout, a valve-shaft and a valve-shaft lever operationally connected to said elongate valve lever on the drive means whereby, intermittent movement of the valve lever on the drive means provides timed porting of fluid into and out of the cylinder.

4. The machine as defined in claim 1 including,
a) a single-throw bell crank secured to a central axis main-shaft;
b) the crank containing at least two bearings disposed at a predetermined distance for journaling a crank-pin about the axis of the main-shaft; the crank pin and said bearings rotationally mounted at a predetermined angle to the rotatable main-shaft through the journaled said bell crank,
c) a wobble drive member operatively connecting the crank-pin for establishing a pivot center,
d) supporting means for said pivot center disposed on the main axis to a fixed central axis point on end wall of said axial piston machine,
e) at least one pair of said elongate piston arm and said elongate valve lever attached substantially perpendicular on said wobble drive member; the piston arm disposed to the valve lever at substantially a right angle, whereby, wobble action of said wobble drive member results in coacting, intermittent timing of piston and valve.

5. An axial piston machine comprising a plurality of single-acting cylinder assemblies including means establishing straight-line piston movement, a swivel-joint means mounting said cylinders in operative relation to valve assemblies; said valve assemblies having control means for porting fluid to and from the cylinders for reciprocally operating a piston within each said cylinder, said piston and valve being operatively connected to a wobble drive means; said wobble drive means including a central pivot supported on the center axis of the machine, a wobble drive member supporting a crank-pin rotatably attached to a central main shaft at a predetermined angle through a journaled bell crank, an elongate piston arm and an elongate valve lever operatively corresponding to each valve and cylinder assembly; said arm and lever disposed relatively on said wobble drive member at substantially right angles for providing sequential movement wherein, the valve and piston movements are mutually exclusive; the improvement includes flexible independent cylinder assemblies combined with a predetermined geometry of coacting valve levers and piston arms wherein the arrangement establishes straight-line motion in said piston reciprocally operated within the cylinders with timed, intermittent porting of fluid into and out of the cylinder for providing rotary power with economy of structure and reduced friction.

6. The cylinder assembly of claim 5 having a straight-line piston guide means comprising:
a) the swivel joint for establishing flexible attachment of the cylinder to the valve assembly,
b) piston disk secured rigidly to a piston connecting rod,
c) a guide tube vertically disposed on a tube bracket in the center of the cylinder to guide the connecting rod and,
d) piston rod ends pivotally connecting the piston rod to the wobble drive means whereby, alignment is operatively established between the cylinder and the piston.

7. An axial piston machine comprising a plurality of single-acting cylinder assemblies connected by swivel-socket joints to valve assemblies to reciprocate pistons operatively connected to a centrally secured wobble drive means; said wobble drive means including a wobble drive member on the center axis of the machine by which a crank pin is operatively journaled to a main shaft at a predetermined angle within a bell crank; said crank pin being operationally secured to the pivot member supporting an elongate piston arm and an elongate valve lever corresponding to each said cylinder assembly in paired concurrence; the paired arms and levers attached perpendicular on said wobble drive member and operationally disposed relatively on the drive member at substantially right angles and linked to said valves and pistons whereby, the arranged improvement establishes intermittent, timed porting of fluid into and out of the cylinder on each power and exhaust stroke of the said piston for producing rotary power with economy of structure and reduced friction.

8. The single-acting cylinder assembly of claim 7 further including a piston guide means guiding said piston disk relative to the cylinder causing the piston to operate in a straight-line movement within the cylinder.
